(19) United States
(12) Patent Application Publication
(10) Pub. No.: US 2005/0086319 A1
(43) Pub. Date: Apr. 21, 2005

(54) System and method for a communication network

(76) Inventors: Teemu Makinen, Jarvenpaa (FI); Zoltan Olah, Espoo (FI); Giorgi Gulbani, Espoo (FI); Serge Haumont, Helsinki (FI); Shaoji Ni, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/504,363

(22) PCT Filed: Mar. 27, 2002
(86) PCT No.: PCT/IB02/00955

(30) Foreign Application Priority Data
Feb. 13, 2002 (EP) EP02/01516

(51) Int. Cl. G06F 15/167

(52) U.S. Cl. 709/213; 709/229

(57) ABSTRACT

The invention proposes a method and system for handling transmission of packets and/or signalling in a system including a node, e.g. SGSN, for transmitting data packets and/or signalling to another entity or receiving data packets and/or signalling from the another entity, e.g. GGSN. The node has a distributed architecture which includes at least two processing units each having their own address or identifier and being able to transmit and/or receive packets and/or signalling to or from the another entity. The node is adapted to send, in case one or more of its processing units is at least temporarily no longer usable or to be used for sending or receiving packets and/or signalling, information to the another entity for informing the another entity thereon. The information sent from the node to the another entity may contain an address or identifier of another processing unit to be used for receiving and transmitting packets and/or signalling instead of the processing unit no longer to be used.

### FIELD AND BACKGROUND OF THE INVENTION

The present invention relates to a system and method for handling connection information in a communication network.

The field of the invention is preferably related to a GSM/UMTS system or method, in particular to a method or, system which includes one or more network entities, preferably GTP entities, e.g. support nodes, for instance GSNs (GPRS Support Nodes) such as SGSNs (Serving GPRS Support Nodes), and RNCs (Radio Network Controllers). Such network entities are capable of exchanging packet or signalling through logical connections (e.g. GTP tunnel).

In some cases, it may be preferable that a support node such as RNC, SGSN, or GGSN (Gateway GPRS Support Node), has distributed architecture.

Distributed architecture of a GTP entity node such as SGSN, GGSN, or RNC means that several computer units (e.g. packet processing units, or control plane processing units) are provided to take care of user packet routing towards and from another GTP entity. If one of the units interrupts operation because of breakdown, maintenance purpose, reset or the like, the GTP entity, e.g. SGSN, is still capable to transmit user packets to, or receive packets from, the another GTP entity, via the other internal units. The GTP entity is thus more fault-tolerant for possible hardware breakdowns or the like.

### SUMMARY OF THE INVENTION

According to one aspect, the invention provides a system as defined in the independent system claim.

According to a further aspect, the invention provides a method as defined in the independent method claim.

The invention allows support of partial reset of an entity, preferably a GTP entity such as RNC, SGSN and GGSN, having distributed architecture.

According to one of the preferred aspects, the invention provides a possibility for a first entity, in particular a GTP entity, e.g. SGSN, to inform another entity such as another GTP entity, e.g. RNC, GGSN or SGSN, which one(s) of its control or user packet processing units identified by e.g., IP address and/or identifier such as TEID (Tunnel Endpoint Identifier) values or logical name have been reset, or it may notify another GTP entity that the PDP contexts handled by one of its packet processing units have been taken over by another unit (identified by e.g., IP address and/or identifier such as TEID values).

This allows another GTP entity to make necessary actions to attached subcribers or given PDP contexts. A GTP entity such as GSN which partially resets may send a GTP message to another GTP entity such as GSN with information about the packet processing unit (e.g. IP-address of that unit and TEID values). Alternatively, a GTP entity (RNC, SGSN) which partially resets may send a RANAP message to RNC or SGSN with information about the packet processing unit (e.g. IP-address of that unit and TEID values).

The TEID values are preferably defined by a TEID range, such as all TEID starting by 10101.

If, for a processing unit (with one IP address), some but not all PDP contexts are lost, and only IP address of this processing unit is used to indicate this fact, all PDP contexts of this processing unit have to be removed or cancelled. When, in accordance with some of the embodiments of the invention, identifier such as TEID values is used to report, the PDP contexts to be removed can be individually indicated. Hence, not all but only the indicated PDP contexts of the processing unit can be removed while the other PDP contexts can still be used.

In case another packet processing unit in RNC or GSN is to take over handling of the PDP contexts, the information about the packet procesing unit (e.g. IP address of that unit) shall also be indicated in the message.

In turn GTP entity, e.g. GGSN, can delete all PDP contexts that were served by the reset unit in another GTP entity, or it may update its PDP context database with the identity of the new packet processing unit. With this message GTP entity can distinguish between whole GTP entity reset (e.g. SGSN system reset) and special packet processing unit reset.

In more detail, the invention provides a method and system including a first entity for transmitting data packets and/or signalling to another entity or receiving data packets and/or signalling from the another entity, the first entity having a distributed architecture which includes at least two processing units each having their own address or identifier and being able to transmit and/or receive packets and/or signalling to or from the another entity, the first entity being adapted to send, in case one or more of its processing units has become at least temporarily unusable, or is at least temporarily not to be used, for sending or receiving packets and/or signalling, information to the another entity for informing the another entity thereon.

The invention is applicable to user plane and/or to the control plane. The processing unit reset mechanism is applicable to packet processing unit reset, and also to the control plane, e.g. signalling processing unit reset. Hence, the invention is providing to maintain logical connection including signalling connection and packet exchanging.

The address may be an IP address.

The identifier can be a Tunnel Endpoint Identifier (TEID), or a logical name, and this logical name is preferably exchanged between said first and another entity during connection creation or modification.

The first entity can be a GTP entity, e.g. a support node, preferably a GPRS support node, preferably a SGSN.

The another entity also may be a node, preferably a support node, preferably a GPRS support node, preferably a GGSN.

The information sent from the first entity to the another entity can be a GTP message.

The information sent from the first entity to the another node may contain the address of the processing unit which is at least temporarily unusable or not to be used.

The information sent to the another entity may include the identifier of the unusable processing unit(s) which is at least temporarily unusable or not to be used.

The information sent to the another entity may include the address of the first entity and the identifier(s) of the unusable processing unit(s).

The information sent from the first entity to the another entity may contain indication of another processing unit to be used for receiving and transmitting packets and/or signaling instead of the processing unit having become at least temporarily unusable.

The first entity may maintain in a protected memory the addresses of all said another entities it is connected to, and is adapted to send, in case one or more of its processing units has become at least temporarily unusable, or is at least temporarily not to be used, for sending or receiving packets and/or signalling, information to all the said another entities stored in its said memory, for informing the another entities thereon.

The processing units may be packet processing units.

The invention can be implemented in a packet-switched network such as a GSM-GPRS or UMTS network, in a circuit-switched network, or may consist of a combination of networks of different type.

The system may consist of a whole network, may be only a part of a network including only the network entity, e.g. support node, having the distributed architecture, and the another entity, or may comprise two or more networks.

### BRIEF DESCRIPTION OF THE DRAWINGS

FIG. 1 shows a basic structure of one embodiment of a system in accordance with the invention;

FIG. 2 illustrates an example of a message flow between support nodes of a network in accordance with an embodiment of the present invention.

### DETAILED DESCRIPTION OF PREFERRED EMBODIMENTS OF THE INVENTION

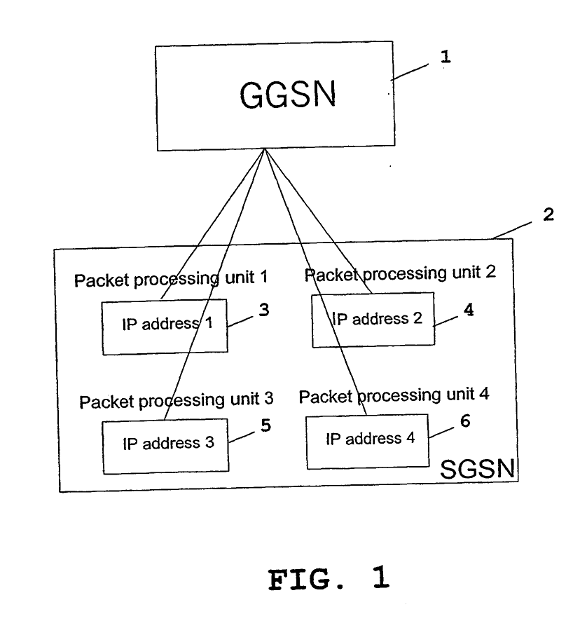

FIG. 1 shows a basic structure of one embodiment of a communication system in accordance with the invention. Only GTP entities are shown which in this embodiment are implemented as GPRS support nodes GGSN 1, SGSN 2. The GTP entities may also be implemented as RNCs (Radio Network Controllers) or network entities of other type, having distributed architecture. Other necessary or optional components such as radio access network, user equipments or mobile or fixed stations (call originating or terminating entities), control entities and other basic network structures or other networks such as PTSN, PDNs etc. are known to the person skilled in the art and are not shown.

FIG. 1 shows the distributed architecture of the SGSN 2. The SGSN 2 includes a plurality of (at least two) processing units which may be signalling processing units. In the present embodiment, the processing units are implemented as packet processing units 3, 4, 5, 6. In the shown embodiment, four packet processing units are provided. The number of (packet) processing units may be different therefrom, e.g. two, three, or more than four (five, etc.). The packet processing units are packet routing units for routing packets between the SGSN 2 and the GGSN 1, and may be implemented as computer units.

In this embodiment, all of the packet processing units 3 to 6 have their own IP-addresses IP address1, to IP address4, as shown in FIG. 1.

All packet processing units 3 to 6 of the SGSN 2 can normally independently of each other communicate with the GGSN 1 as shown by lines in FIG. 1.

GGSN 1 comprises, or cooperates with, a database which includes PDP contexts. The PDP contexts in the database include the identities, e.g. addresses such as IP addresses, of the packet processing units 3 to 6 of the SGSN 2 which are able to transmit and receive data packets to and from the GGSN 1. The GGSN 1 can create or update new PDP contexts when a new data processing unit of the SGSN 2 is able to transmit and receive packets to and from the GGSN 1. Further, the GGSN 1 can delete PDP contexts related to a packet processing unit of the SGSN 2 which is no longer to transmit and receive packets to and from the GGSN 1, e.g. caused by a reset of this unit.

In accordance with the invention, the support node having the distributed architecture, that is the SGSN 2 in this embodiment, is implemented to be able to inform another support node in communication therewith, that is the GGSN 1 in this embodiment, that one (or more) of its packet processing units 3 to 6 are out of order, e.g. have been reset, or it may notify GGSN 1 that the PDP contexts handled by one of its packet processing units 3 to 6 has been taken over by another unit 3 to 6 (identified by the IP address). This allows GGSN 1 to perform necessary actions to those subcribers that are attached.

The SGSN 2 preferably sends a message, e.g. a GTP message (e.g. control plane, or a signalling GTP message), to the GGSN 1 which message includes information about the presently at least temporarily unusable packet processing unit (IP-address of that unit). In case there is another packet processing unit in SGSN 2 to take over handling of the PDP contexts handled by the now unusable unit up to then, the IP address of the new-unit is preferably also indicated in the message to the GGSN 1. In turn GGSN 1 can delete all PDP contexts that were served by the reset SGSN packet processing unit, or it may update its PDP context database with the identity of the new serving SGSN packet processing unit. With this message from the SGSN 2 informing the GGSN 1 on an unusable, i.e. presently no longer usable unit 3 to 6, the GGSN 1 can make a difference between whole SGSN system reset and special packet processing unit blocking or reset allowing continued use of the SGSN via still functioning units.

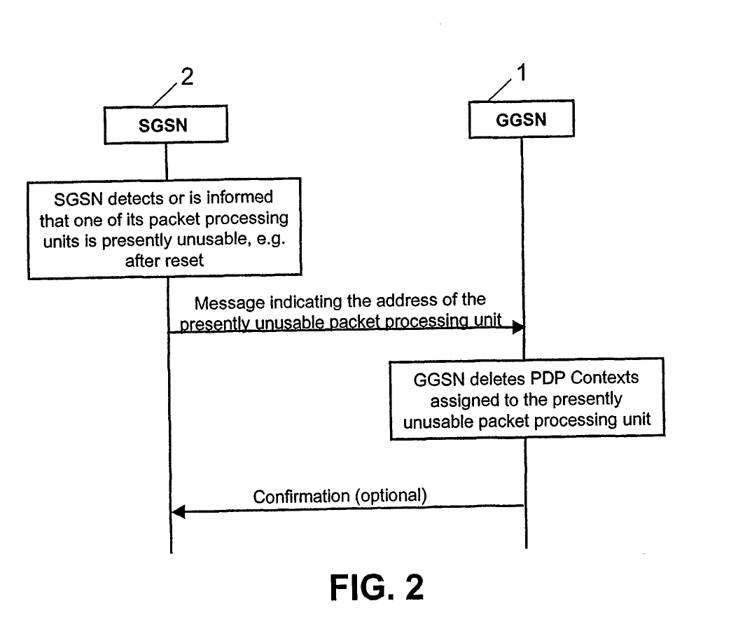

FIG. 2 illustrates the functioning and message flows in an embodiment of the invention which may have the structure shown in FIG. 1. The SGSN 2 is implemented to detect, or to be informed, (e.g. by a packet processing unit resetting means) if one or more of its packet processing units is presently unusable, e.g. after reset, and is thus at least temporarily not usable or to be used. When the SGSN 2 detects, or is informed on, such a situation, it sends a message to the GGSN 1 which message indicates the address of the presently unusable packet processing unit. The GGSN 1 reacts in an appropriate manner, e.g. by GGSN deleting the PDP Context(s) assigned to the presently unusable packet processing unit. As optional feature, the GGSN 1 may send a confirmation to the SGSN 2 for confirming the receipt of the message from the SGSN 2.

GGSN 1 preferably maintains a pointer to the serving SGSN unit at each PDP context record to provide an association between contexts and SGSN units.

Preferably, GTP protocol is used between SGSN and GGSN. The invention provides a mechanism that allows SGSN to inform GGSN that only one (or more up to all) of its processing units has been reset or is at least temporarily no longer usable. The distributed packet and/or signaling handling in SGSN can therefore be continued despite partial reset.

This embodiment of the invention allows to distinguish between total node, e.g. SGSN, reset and partial node, e.g. SGSN, reset, i.e. packet processing unit resets, the partial reset allowing continued communication between the node, e.g. SGSN, and another node, e.g. GGSN. The invention thus provides means to restrict e.g. the number of PDP contexts to be deleted in GGSN in case of a partial reset in SGSN to a more reasonable .extent.

In another embodiment of the invention, a node, e.g. a GTP node such as SGSN, RNC, GGSN, may have only one IP address but many processing units (typically referred to as clustering). In this case, each processing unit is uniquely identified by the combination of the IP address and an identifier. A first preferred option is that this identifier is a range of TEID. This is particularly suitable if the node uses the TEID to distribute the traffic among its processing units. In the GTP protocols TEIDs are exchanged during the establishment or modification of the GTP tunnel. In a second option, this identifier is a logical name allocated by each node to its processing units, such as “processing unit1”. Then this option of the invention includes the feature of exchanging during the GTP tunnel establishment or modification, a processing unit logical name, identifying the processing unit together with the IP address of the node. This option presents the advantage of maintaining a logical independence between mechanism used to identify a GTP tunnel end point and reset mechanism.

Then, in case of a partial reset, the node will initiate a reset procedure indicating, to another node, the processing unit identifier i.e. logical name or TEID values identifying the processing unit(s) to be, or having been, reset, in addition to the IP address of the node. The another node receiving the reset message will mark the one or all the relevant PDP contexts (or RAB contexts) having both IP address and processing unit identifier or TEID values with the IP address, as invalid. Depending on the case, the another node may either reestablish the context (e.g. sending new RAB establishment) or deactivate the PDP context.

In addition, if the clustered node (i.e. the node having many processing units, e.g. a GGSN) preferably stores in a protected memory the list of nodes(e.g. SGSN) it is connected to. In case of partial reset, the GGSN reset process will access this memory and send a reset message to all the nodes (SGSN) stored in this memory.

Generally, GTP protocol is used between SGSN and GGSN, and RANAP protocol is used between SGSN and RNC. The protocol used for transmitting the identifier can thus be GTP or RANAP protocol, or any other suitable protocol.

Similarly, the protocol used to carry the reset message may be GTP or RANAP protocol, or any other suitable protocol.

Basically, GTP tunnels are established/modified using RAB establishment procedure over Iu interface, and create or update PDP context messages are sent over Gn/Gp interface.

Thus, the embodiments of the invention provide a solution not only for Gn/Gb (or Gp) interfaces but also for Iu interface.

Although preferred embodiments have been described above, the invention is not limited thereto and may also be implemented in networks of different types using serving nodes of different structure such as MSC/VLR, RNC, clustered network elements etc.

1-23. (canceled)

24. System including a first entity for transmitting data packets and/or signalling to another entity or receiving data packets and/or signalling from the another entity, the first entity having a distributed architecture which includes at least two processing units each having their own address or identifier and being able to transmit and/or receive packets and/or signalling to or from the another entity, the first entity being adapted to send, in case one or more of its processing units has become at least temporarily unusable, or is at least temporarily not to be used, for sending or receiving packets and/or signalling, information to the another entity for informing the another entity thereon,
wherein the first entity maintains in a protected memory the addresses of all said another entities it is connected to, and is adapted to send, in case one or more of its processing units has become at least temporarily unusable, or is at least temporarily not to be used, for sending or receiving packets and/or signalling, information to all said another entities stored in its said memory, for informing the another entities thereon.

25. System according to claim 24, wherein the address is an IP address.

26. System according to claim 24, wherein the identifier is a Tunnel Endpoint Identifier (TEID).

27. System according to claim 24, wherein the identifier is a logical name, and this logical name is exchanged between said first and another entity during connection creation or modification.

28. System according to claim 24, wherein the first entity is a GTP entity.

29. System according to claim 24, wherein the first entity is a support node, preferably a GPRS support node, preferably a SGSN.

30. System according to claim 24, wherein the another entity is a node, preferably a support node, preferably a GPRS support node, preferably a GGSN.

31. System according to claim 24, wherein the information sent from the first entity to the another entity is a GTP message.

32. System according to claim 24, wherein the information sent from the first entity to the another node contains the address of the processing unit which is at least temporarily unusable or not to be used.

33. System according to claim 24, wherein the information sent to the another entity includes the identifier of the unusable processing unit(s) which is at least temporarily unusable or not to be used.

34. System according to claim 24, wherein the information sent to the another entity includes the address of the first entity and the identifier(s) of the unusable processing unit(s).

35. System according to claim 24, wherein the information sent from the first entity to the another entity contains indication of another processing unit to be used for receiving and transmitting packets and/or signaling instead of the processing unit having become at least temporarily unusable.

36. Method for handling data packet transmission and/or signalling in a system including a first entity for transmitting data packets and/or signalling to another entity or receiving data packets and/or signalling from the another entity, the first entity having a distributed architecture which includes at least two processing units each having their own address or identifier and being able to transmit and/or receive packets and/or signalling to or from the another entity, the first entity sending, in case one or more of its processing units has become at least temporarily unusable, or is at least temporarily not to be used, for sending or receiving packets and/or signalling, information to the another entity for informing the another entity thereon,
wherein the first entity maintains in a protected memory the addresses of all said another entities it is connected to, and sends, in case one or more of its processing units has become at least temporarily unusable, or is at least temporarily not to be used, for sending or receiving packets and/or signalling, information to all said another entities stored in its said memory, for informing the another entities thereon.

37. Method according to claim 36, wherein the address is an IP address.

38. Method according to claim 36, wherein the identifier is a Tunnel Endpoint Identifier (TEID).

39. Method according to claim 36, wherein the first entity is a GTP entity.

40. Method according to claim 36, wherein the first entity is a support node, preferably a GPRS support node, preferably a SGSN.

41. Method according to claim 36, wherein the another entity is a node, preferably a support node, preferably a GPRS support node, preferably a GGSN.

42. Method according to claim 36, wherein the information sent from the first entity to the another entity is a GTP message.

43. Method according to claim 36, wherein the information sent from the first entity to the another node contains the address of the processing unit which is at least temporarily unusable or not to be used.

44. Method according to claim 36, wherein the information sent to the another entity includes the identifier of the unusable processing unit(s) which is at least temporarily unusable or not to be used.

45. Method according to claim 36, wherein the information sent to the another entity includes the address of the first entity and the identifier(s) of the processing unit(s) which is at least temporarily unusable or not to be used.

46. Method according to claim 36, wherein the information sent from the first entity to the another entity contains indication of another processing unit to be used for receiving and transmitting packets and/or signalling instead of the processing unit having become at least temporarily unusable.
